(19) United States
(12) Patent Application Publication
(10) Pub. No.: US 2015/0348067 A1
(43) Pub. Date: Dec. 3, 2015

(54) COMPUTER IMPLEMENTED FORECASTING SYSTEM AND METHOD

(71) Applicant: Cash Analytics Limited, Dublin (IE)

(72) Inventors: Conor DEEGAN, Dublin (IE); Martin GILLESPIE, Dublin (IE); Chris BLAKE, Dublin (IE); Gareth STENSON, Dublin (IE)

(73) Assignee: CASH ANALYTICS LIMITED, Dublin (IE)

(21) Appl. No.: 14/716,389

(22) Filed: May 19, 2015

Related U.S. Application Data
(60) Provisional application No. 62/002,019, filed on May 22, 2014.

(51) Int. Cl. G06Q 30/02

(52) U.S. Cl. CPC G06Q 30/0202

(57) ABSTRACT

A rolling cash forecasting tool that captures and analyses mixed frequency forecast cash flows is described.

### FIELD OF THE INVENTION

The present invention relates to a rolling cash forecasting tool that captures and analyses mixed frequency forecast cash flows.

### BACKGROUND

Cash flow forecasting is a critical task undertaken by corporate treasury and finance teams in organizations worldwide. It involves attempting to predict upcoming cash payments and receipts in an effort to understand future cash positions and funding requirements. Accurate cash forecasting helps effectively manage risk and optimize capital structures by minimizing debt and interest levels.

Cash flow forecasting is routinely ranked as at least a top three problem for corporate treasurers and risk managers. This is due to the fact that forecasting cash flows across numerous subsidiaries in multiple currencies and time frequencies is extremely challenging and tools available to date cannot cater for the complexities of large international organizations.

Existing forecasting applications broadly fall into two categories, either they model from existing data or they forecast in a single calendar unit i.e. day, week, month etc. If a company wants to collect actual forecasts from the part of their organization, they have typically used spreadsheets as these can have mixed frequency i.e. forecast 2 weeks in days, then the next 4 weeks in weeks. Unfortunately spreadsheets can't be versioned or reported on for trends.

Due to the lack of a viable system based solution the focus of cash forecasting for most companies is on manual administration. This typically involves the collection and manual consolidation of cash flow information from business units and subsidiaries which is both time consuming and fraught with potential for error. The primary value in cash forecasting is in the analysis of cash flow information which helps an organization understand their future cash requirements. Due to the over emphasis on administration over analysis most organizations derive limited value from cash flow forecasting and remain open to cash and liquidity risks.

### BRIEF DESCRIPTION OF THE DRAWINGS

These and other features of the invention will become more apparent from the following description in which reference is made to the appended drawings wherein:

FIG. 1 is a high level forecast entity relationship diagram according to an example embodiment.

FIG. 2 is an example input screen to coordinate the interrelationship between the gregorian calendar of the everyday user and the financial reporting calendar, according to an example embodiment.

FIG. 3 is a flowchart of the steps involved in creating a high level forecast model according to an example embodiment.

FIG. 4 is a flowchart showing the process of creating a forecast series based on a forecast model according to an example embodiment.

FIG. 5 is a flowchart showing the process of creating a single forecast within the series according to an example embodiment.

FIG. 6 is a flowchart showing the process of building the forecast items for a reporting unit and currency according to an example embodiment.

FIG. 7 is a flowchart showing the process of rolling a forecast series from one forecast to the next according to an example embodiment.

FIG. 8 is a sample management screen for preparing an individual forecast submission for opening according to an example embodiment.

FIG. 9 is a financial calendar entity relationship diagram according to an example embodiment.

FIG. 10 is a diagram showing the relationships between the actuals data and the various forecast submissions according to an example embodiment.

FIG. 11 is a sample screen showing input of actual data and forecast data at the same time, in a logical unified way, according to an example embodiment.

### DETAILED DESCRIPTION

A system for generating, managing and rolling of a multi frequency rolling forecast is outlined herein. Numerous specific details are provided, to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

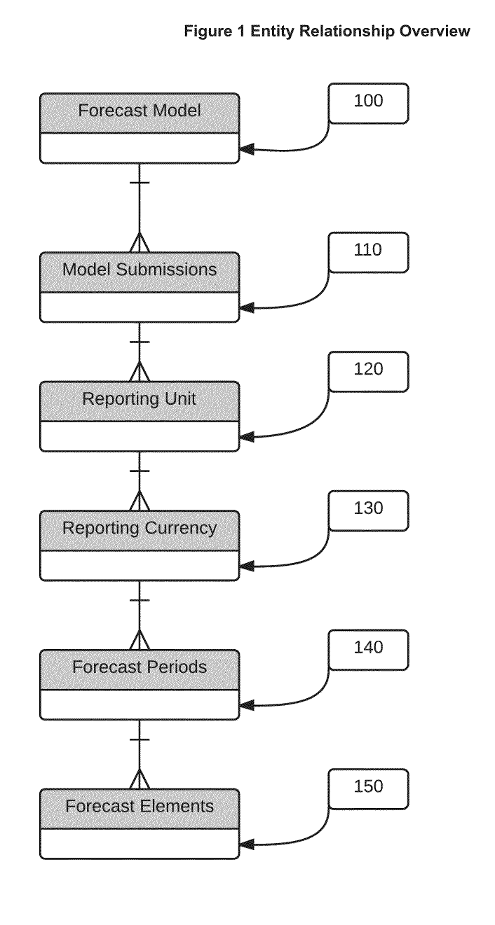

FIG. 1 shows the high level entity relationship diagram is shown in an embodiment. This shows the general structure and composition of a series of forecasts.

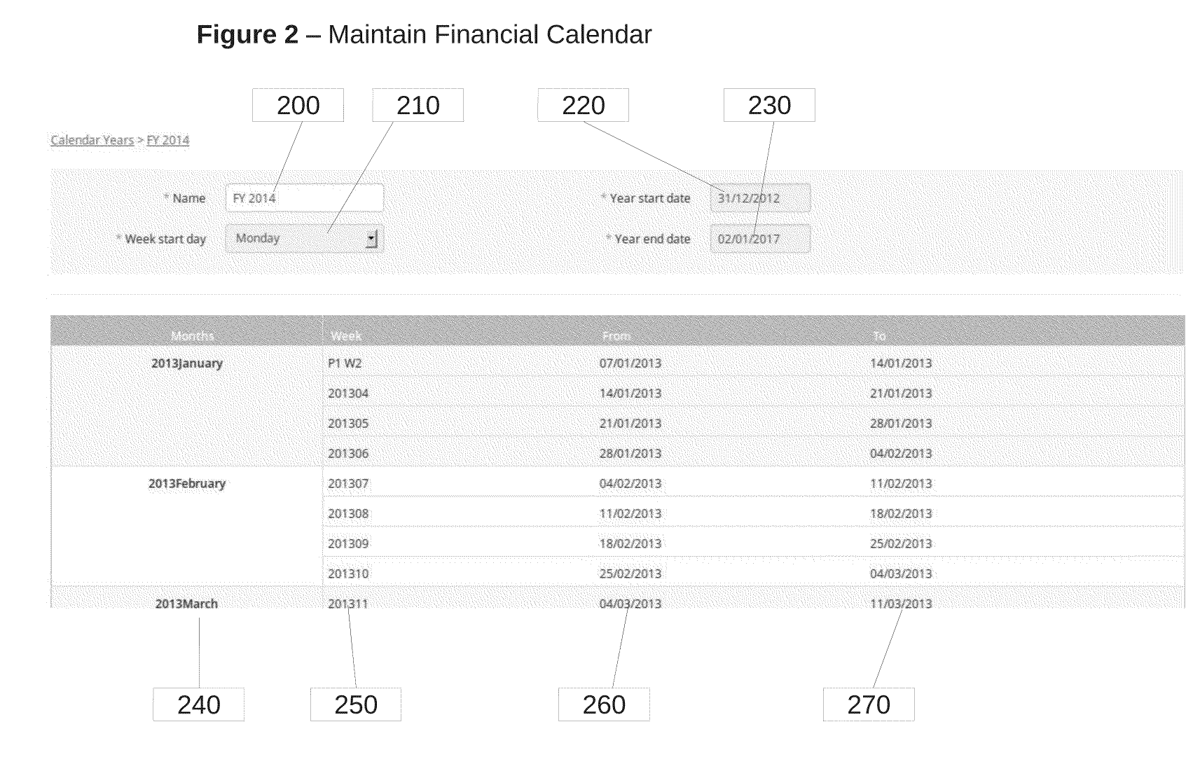

At the highest level is the forecast or parent model 100 which defines a parent model within the data architecture. This parent model 100 contains a number of attributes and is the parent that binds the series of forecasts together. The main attributes and steps involved in the creation of this are outlined in FIG. 2. Sitting below the parent model are the forecast submissions 110, each of these represents a complete forecast as at a given time. Each of these forecast submissions have the parent model's id as an attribute.

A forecast submission comprises a number of reporting units 120. These units could be based on one of a number of different elements—for example a person, business unit, project or department. In this respect a data element defining a reporting unit can be generated for anything that an organization wants to forecast on. These reporting units can themselves have child units. Each reporting unit can report in a number of different currencies 130.

Within the data architecture each of the plurality of currencies have a related series of forecast periods 140 for a single reporting unit in a currency. Each of these periods is a time period i.e. a day, week, fortnight, month, quarter. The periods in their entirety make up the forecast submission for that unit in a currency. For instance, when you are at this level you would effectively have the information for “Forecast for Week 2 Period 1 for London Business Unit in GBP for the Forecast Submission at 10th of April”.

Under each forecast period is the actual forecast elements that are forecasted 150. These include such items as; sales, investments, taxation, expenditure to name a few.

FIG. 2 shows an example of a sample financial calendar management screen provided in accordance with the present teaching. Financial organizations have a different calendar to the Gregorian calendar. Some might end their year in June. They may call January 2014, P6 2014. They may start their week on a Tuesday. Their needs to be a way to relate this to the Gregorian calendar and also between the different time frequencies. An organization needs to be able to find the relation between Period 1 and Week 1 in order to do mixed frequency forecasting.

The role of this screen is to define and maintain the relationship between the financial calendar of the organization to the Gregorian calendar of everyday use where in the financial year is further broke down into other periods i.e. day, week, month, quarter etc. It includes a name for the calendar year 200, the start date 220 and end date 230. It also includes the start day of the business week 210. The system using this information can generate a number of series of periods in different frequencies, showing their relationship to each other. From here the user can change the name of the weeks 250 or months 240 to align with the names within the organisation i.e. P1 W1 rather than January.

In this screen the financial weeks that compose a financial month can be manipulated. In some cases the month may contain 5 weeks. Or change the start 260 and end date 270 of a week.

This may not exactly align with the Gregorian calendar. The base validation on this screen will be that, while dates can be moved, each time frequency must a sequential series with no gaps, as is the case with the Gregorian calendar.

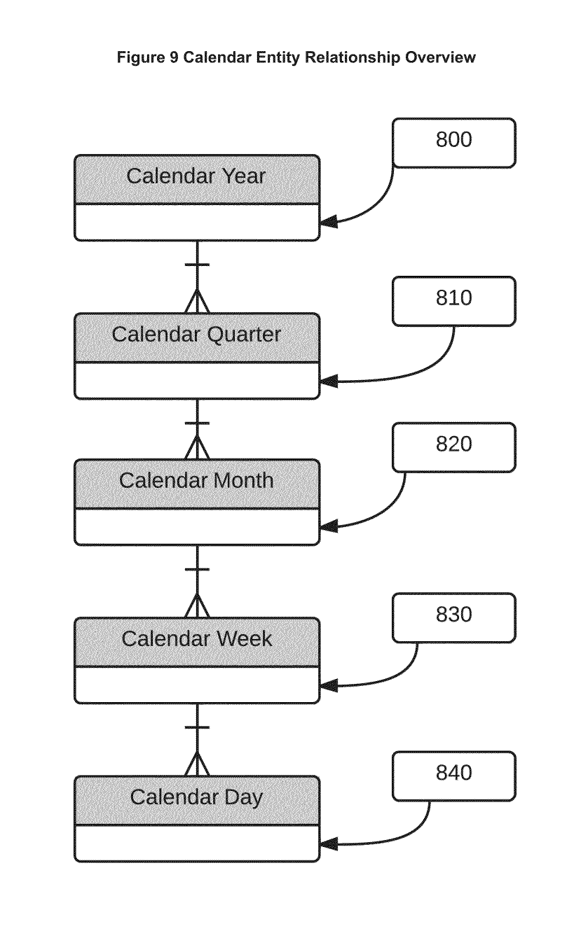

The structure of the underlying data and the interrelationships is further outlined in FIG. 9.

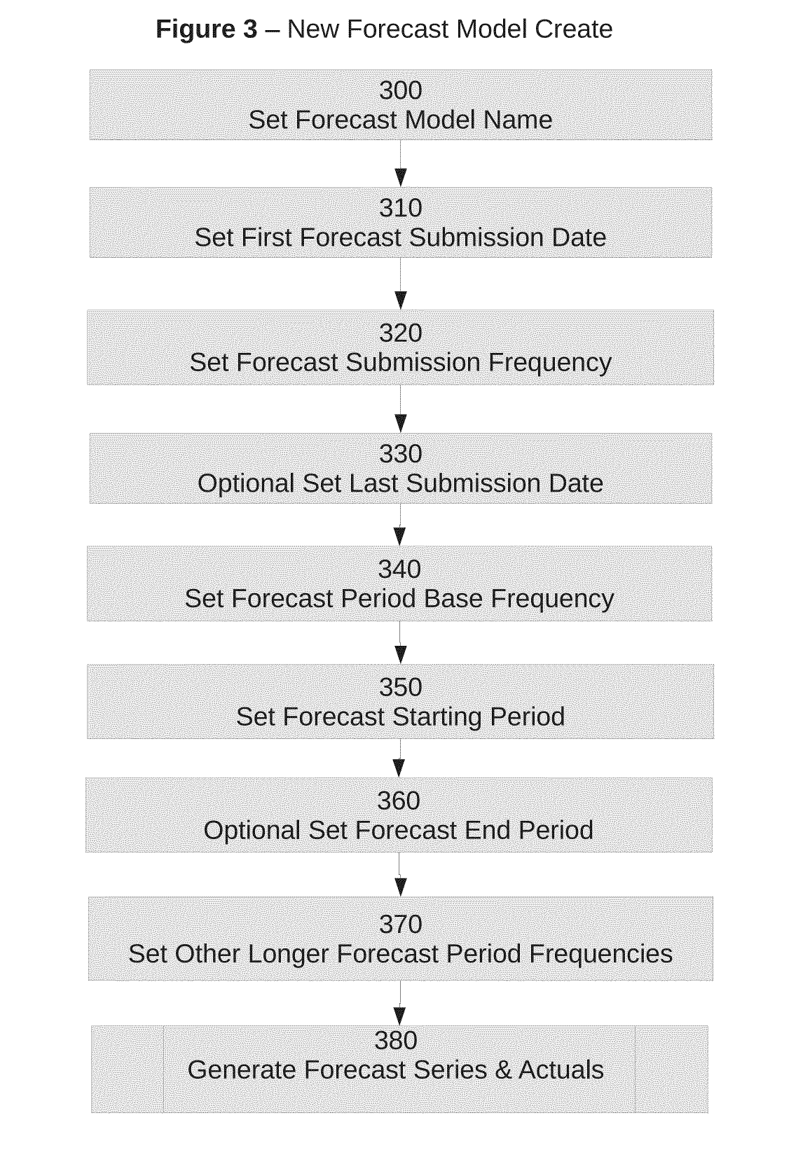

FIG. 3 shows the steps involved in setting the basic information required to create a rolling forecast in an embodiment. The forecast model needs a name 300 which is used to identify it by the users. Next we need to set the first submission date 310 of the series. The forecast is submitted at regular intervals starting from this date. To create the series of forecasts we need the forecasting submission frequency 320, this can be daily, weekly, fortnightly etc.

There may be an optional last submission date 330. Alternatively this can be left blank and the forecast can roll indefinitely, or to a point based on business rules.

Next we need to set the forecast period base frequency 340 and starting period 350. This is different than the forecast start date. The forecasting start period is the first forecast period of the first submissions in the base forecasting frequency. For instance, you may be forecasting monthly from Jan 2014 but you first forecast submission date is 1st December 2013. There may be an optional last forecast period 360; alternatively there will typically be a system parameter to tell how long each forecast is for, for instance 6 months out.

The base forecasting frequency is important as it tells the system what the composition of each forecast looks like. In this way a determination may be made with regard to the duration of the time period for which the forecast pertains in the context of a series of days, weeks, months etc. On top of the base forecast frequency, it is possible to select longer frequencies to roll up the forecast to 370. This will allow the user to set the points at which the forecast's frequency will change from the base frequency to the longer frequency. For instance a first iteration may provide a forecast in the terms of weeks for the first month of a forecast, then switch to months for the next 5 months. This would give you a 6 month forecast with greater granularity for the first 4 or 5 weeks (when you would need it).

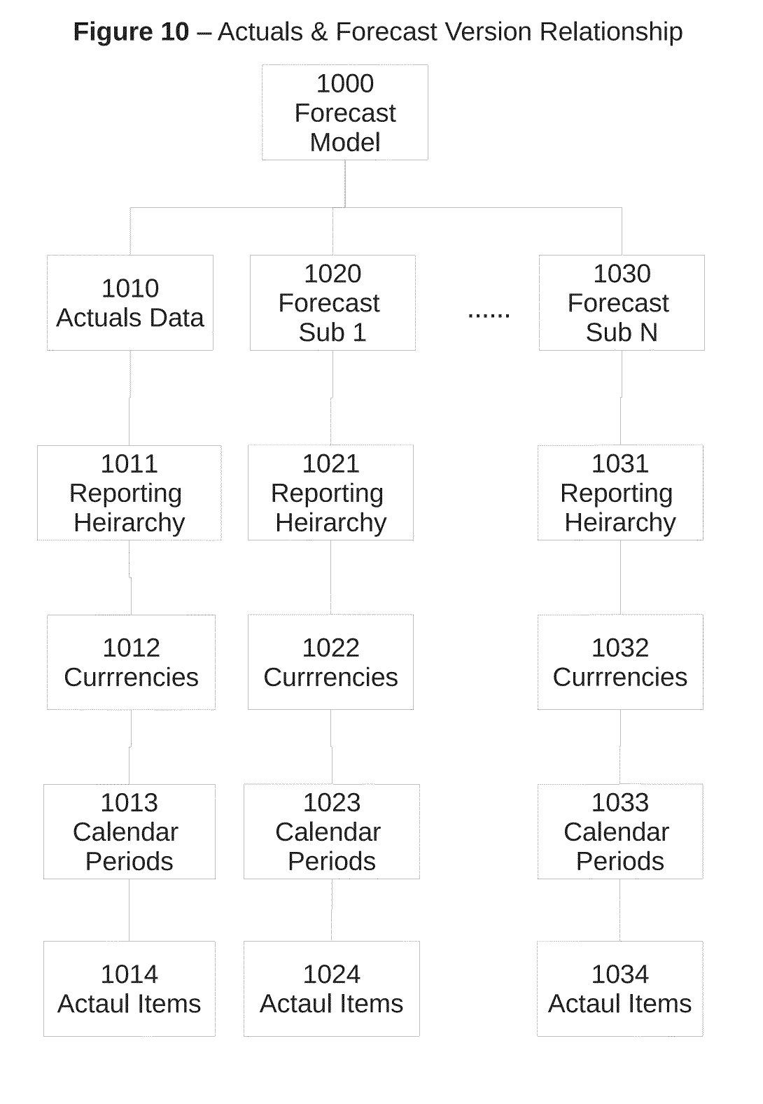

Once you have the above you have enough to generate a skeletal forecast series 380. The forecast series is a series of individual forecasts. The actuals is a single structure of records holding the reporting units actual data for the entire range of the forecast model. While the forecast has many versions, moving forward in time, there is one set of actuals one for each period. This holds the actual data for the reporting units, once it is available. This can then be used later to compare to forecasts (for accuracy among other things). There is more information on this in FIG. 10.

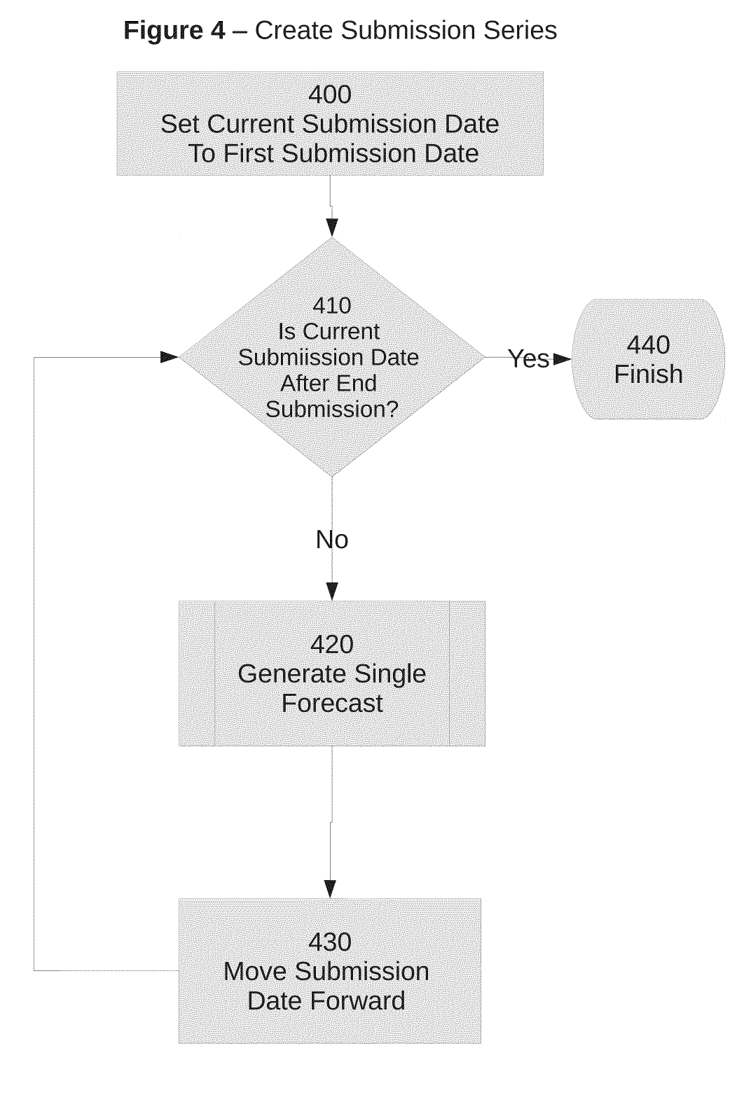

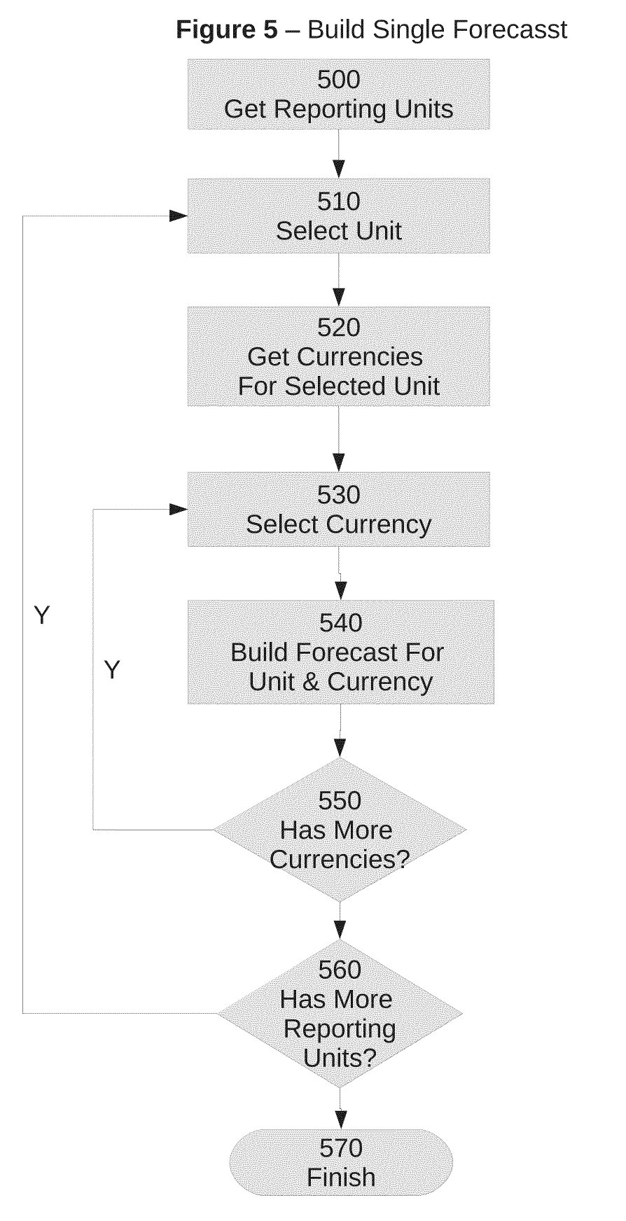

FIG. 4 shows the process involved in creating a forecast series in an embodiment. The start date of the forecast model is the date the first forecast is due 400. The controller can use this first date and submission frequency to generate a series of forecasts, one for each date from the first date moving the series forward 430 using the forecast submission frequency and the system financial calendar. For each forecast submission the controller builds the entire forecast structure 420. This is further described in FIG. 5. The series can be generated until a supplied end date, the financial calendar end date, or to some other point depending on the embodiment 410.

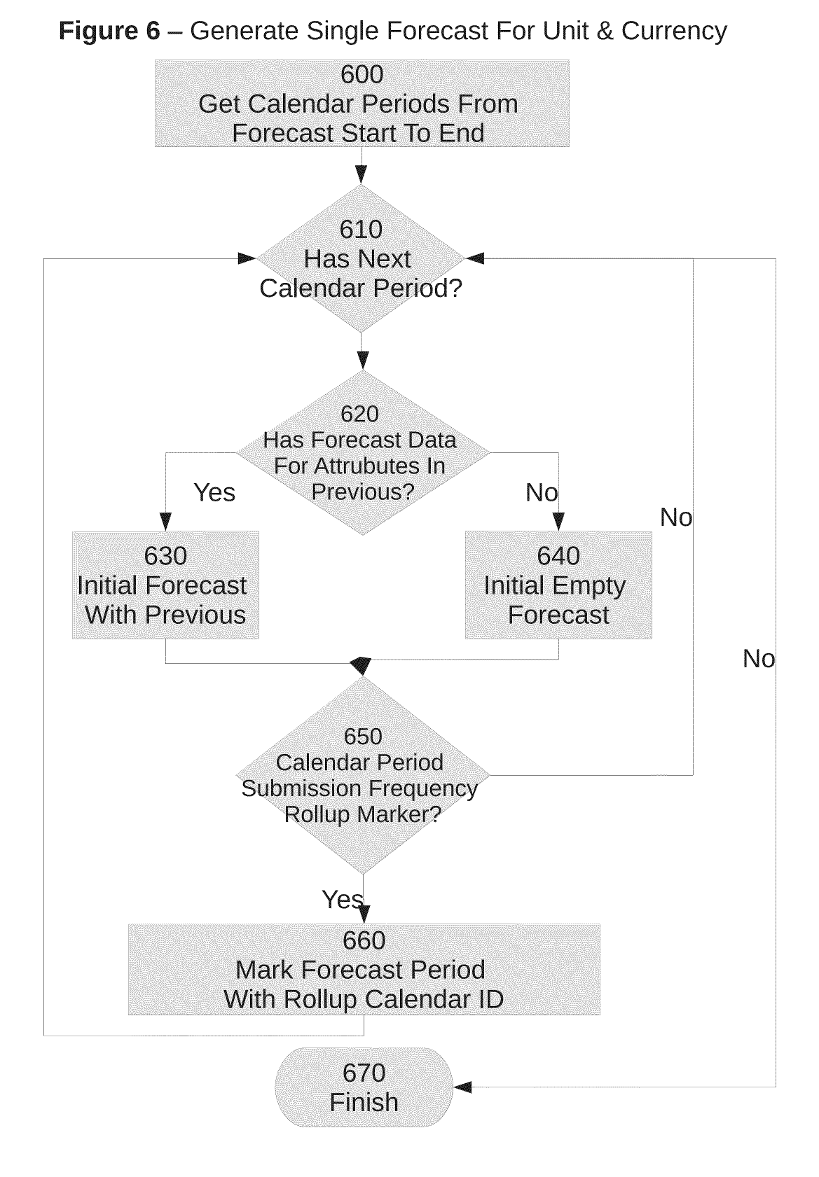

FIG. 5 shows the process of building a single forecast within the series in an embodiment. A single forecast is composed of a number of reporting units 500, which can include business units, projects, departments or people, so the first step is to retrieve these so that we may build each 510. For each reporting unit we need to retrieve the currencies for which a cash forecast is being created 520. Selecting a currency 530 combined with the selected business unit means we now have enough information that we can then build a forecast for that reporting unit currency combination 540. The actual build is further outlined in FIG. 6. This process is repeated until all currencies 550, and all reporting units 560, have been built. At that point we are finished 570.

FIG. 6 shows a workflow diagram of generating the forecast elements for a single reporting unit and currency in an embodiment. The system needs to get the entire set of periods in the base forecast frequency 600 using the actuals to period id from the submission and ending on the end date of the parent forecast model (or an end date as defined by the business rules e.g. the end of the financial calendar year).

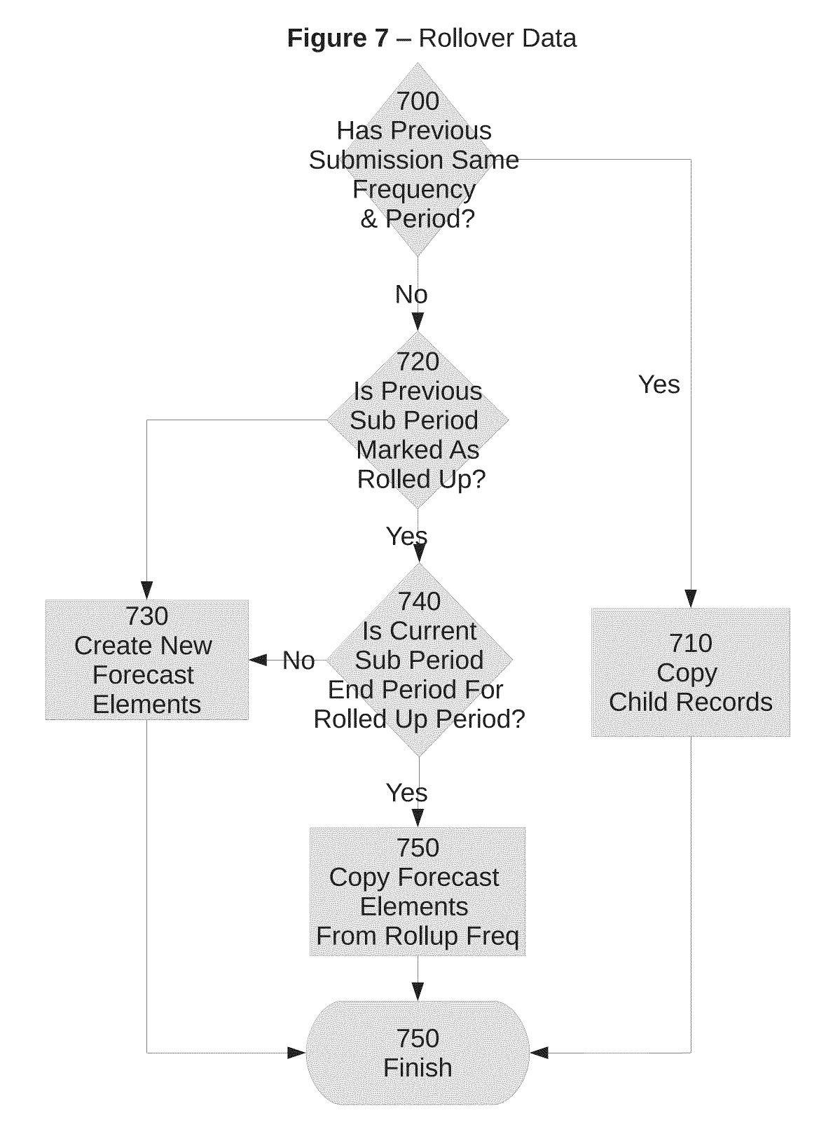

The controller needs to loop through these periods 610 and apply logic to each. For each calendar period in the set the controller needs to see if there was a data for the calendar period, reporting unit and currency in the previous forecast submission 620. If there was then the controller will copy this data into new records 630 so that the users will have this information as a starting point, rather than having to rekey this information (as it may not have changed). It is important to copy this rather than linking it as we need to keep the previous submission intact. This process is further elaborated on in FIG. 7.

If there is no previous forecast for these attributes a new empty forecast is created containing the items being forecast 640. This checking and copy process is key for rolling forecasts as it avoid mass rekeying of unchanged data, while allowing updates which don't affect previous submission. After all the periods have been processed the forecast is complete 670.

All this occurs on records marked with the base frequency. Now after this point we check to see if the model forecast is using mixed frequencies. If it is then we check if we have moved to the point at which we go to a longer forecast frequency i.e. move from daily to weekly 650. This information will be available at the forecast submission level which have attributes flagging point at which to switch. If the switch has occurred we mark the forecast period as rolled up, and set the rollup frequency attribute and the rollup calendar id on it two. It is now effectively has two views, a calendar period for the short frequency and one for the longer frequency. This allows the system to report at either level.

FIG. 7 is the process flow in rolling a forecast over in an embodiment. This is a core function of the system. Rolling over for a reporting unit and currency involves creating a new set of forecast entries for each calendar period that the single forecast covers. Since the forecast is rolling it will, most likely, look further into the future than the previous (as time has moved) on. It will also start later than the previous forecast submissions.

For instance forecast submission one could be looking 6 months in the future from Jan, forecast two could be looking six months in the future from February. In this example they only have 5 months of data in common. This means that we can copy the last five months of forecast one into the first five months of forecast two matching by calendar period id). The last month of forecast two is new data.

What can make this process more complicated is the case where we have mixed frequency forecasts. The above example would be written as; the organisation is running a six month rolling forecast where the first 2 months are forecasted weekly and the remaining four are forecast monthly. When it comes to the rollover we have data for the same periods but just in different frequencies.

In the workflow we can see the logic required to copy the data. First we check if we have a previous submission and see if also matches on frequency 700. If it does then it is a straight copy of this data 710. If there is not a match we need to see if there is data for the same period but at a different frequency i.e. if the previous period is a rollup period (it is longer than the forecast models base frequency) 720. If it's not then we create new records 730. If it is the check if the current period is the end period of the longer previous rolled up period 740. If it is then we copy a month into the last week on a rollover, if the month is forecast in weeks subsequently 750. All other weeks in the month would be zeroes. This rule could also be that we copy the data into the start week when moving from month to week.

To further expand on this rule. If we had a monthly forecast for March in the previous submission and in this submission we were looking for Week 13 data. If week 13 is the end period for March according to the financial business calendar, then we would copy the month's data into the week (and by corollary all other weeks would be zero for weeks in March).

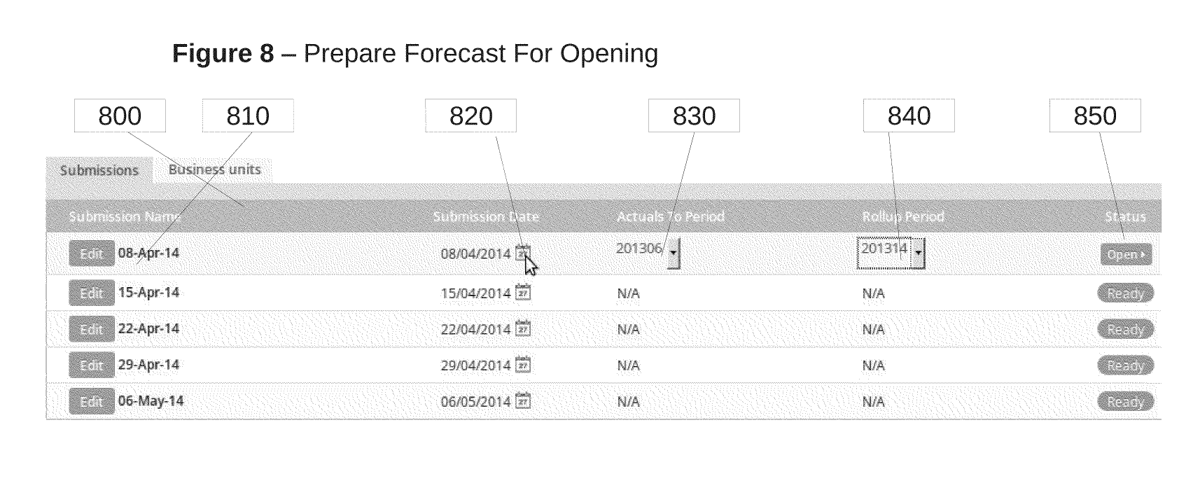

FIG. 8 shows a screen to set the attributes before opening a new forecast submission in an embodiment. The system has a screen which lists of forecast submissions 800, this gives an overview of the entire forecast model. There is an identifier for the submission which can be the date of the submission or a name 810. There is a calendar control to set the submission date 820. This is the date the forecast is due by. The system alerts users when this date approaches.

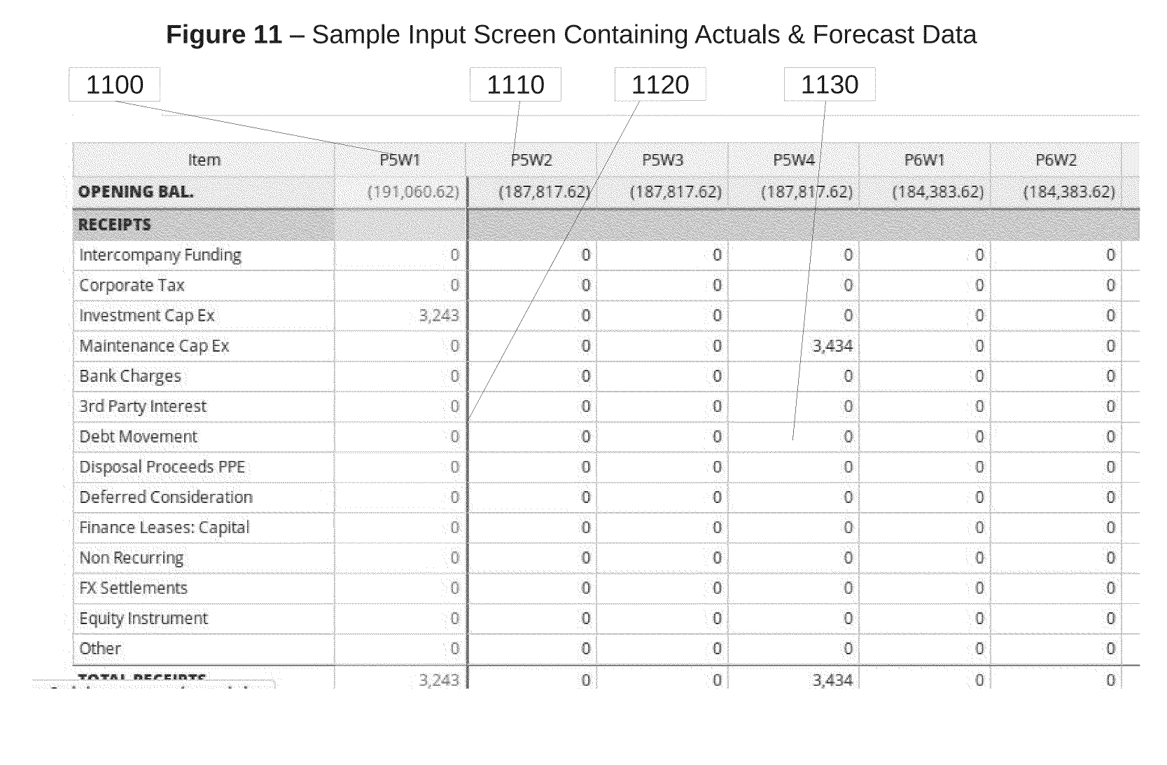

The user can set the start forecast period by setting the ‘actuals to’ list. This will set the point at which the forecast starts. It will also tell the system that the actuals are available for input up to the period selected 830. The input of the data is show in FIG. 11. In this instance the forecasting model is mixed frequency, weekly and monthly. The users are allowed to set the point at which the forecast period frequency moved from weeks to months 840, in this case 201314. The list for the rollup periods is only populated with weeks that are the endpoints of months. In this embodiment the system does not allow frequency changes in the middle of the longer duration period i.e. a rollup can only happen at the end of week, or end of month. This is to facilitate rollover and grouping of data in reports.

In this embodiment there is an on screen indication of the status of the submission 850. In a rolling forecast only one forecast submission may be open at a time. It is the role of the parent mode forecast entity to manage the forecast series, including when a forecast submission may be opened for data entry. When the attributes are set the open submission button may be clicked. This alerts the reporting units that there is a new submission waiting.

FIG. 9 shows the entity relationship of the financial calendar entities in an embodiment. The purpose of these entities is to manage the relationship between the different time frequencies that the organisation is working with. An organisation's financial year will usually run to a different year than the Gregorian calendar year. They may call the year something like FY2012. Each year 900 is composed of a four quarters 910. Each quarter is composed of a number of calendar months 920. The starting month and end month is configurable. It may not be the same as the user's quarter.

Each calendar month contains a number of calendar weeks 930. The start week and end week of the month is configurable. Each calendar week is composed of a number of calendar days 940. Again the start and end day is configurable. The calendar day is linked to the Gregorian calendar.

FIG. 10 shows the relationship between the main structures of the forecast model and the interrelationship between actuals data and the forecast submissions in an embodiment. When a forecast model 1000 is created two main structures are created, the actuals data structure 1010 and the model submission structure (containing many submissions 1020 & 1030).

The actuals data structure contains the reporting hierarchy 1011 which is the hierarchical reporting structure of business units, department, projects or people that financial forecasts are created for. Each of these has forecasts in one or more currencies 1012. For each of these currencies there is the entire series of periods 1013 for the range of calendar periods that the forecast model covers. Under these periods are the actual financial elements 1014 such as sales, taxation etc. which are being forecasts. The idea here is that this structure will hold the actual inflows and outflows that occurred so that we can measure the accuracy of the forecasts later. This structure mirrors the forecast structure which allows cross joins in the database later. There are N numbers of forecast submissions where N is the number generated by the system 1020/1030. It could be one per day, week, and month or on some other ad hoc basis. These forecasts mirror each other is their structure, however there may be extra elements at each level. For instance you may have extra reporting units or currencies for later forecasts. However the broad hierarchical structure will be the same 1021/1031. This is the case at all levels down to the forecast data 1024/1034.

There is only one version of the actuals structure, as by its nature, there is only one actual sales figure, whereas there can be any number of forecasts. By sitting these under a forecast model parent and by mirroring the structures, it allows for us to compare forecasts to actuals or forecasts to other forecasts.

FIG. 11 show a sample input screen facilitating the input of actuals achieved to a point alongside input the forecasts for the future in an embodiment. The basic structure is a two dimensional array of data. On the left we have the opening balance on the top and then all the elements we are forecasting on. On top we have the financial calendar periods. These could be days, weeks, months or a mix of these 1110. They will however be sequential with no gaps and move forward chronologically left to right. For instance if the forecast is for four weeks and then 5 months the fourth week should end the day before the 1st month starts.

To facilitate data entry of actuals and forecasts the system will highlight or put a line delineating the move from actuals to forecasts 1120. The data itself will be entered into a cell 1130.

It will be appreciate from the above exemplary disclosure that the present teaching provides a computerized forecast system and method configured to handle mixed frequency rolling cash forecasts. Within this context a system and method per the present teaching advantageously provides a method of rolling over of one forecast into the next. This advantageously allows a user to provide a more dynamic forecasting environment than heretofore possible. By allowing a user to dynamically modify the time period and durations of any one forecast it is possible to integrate longer frequency financial data into a shorter one. It is also possible within the context of the present teaching to provide a versioning of forecasts that facilitates generation of data variation reporting. It is also possible within the context of the present teaching to provide a system and method to handle the interdependence in various time frequencies for financial forecasting which may be facilitated through at least one of recording actual data in one or more parallel structures and then inputting actual data and forecast data at the same time to allow a cross comparison between the two data structures.

It will therefore be appreciated that while the present teaching has been described with reference to exemplary applications and implementations that modifications can be made without departing from the spirit and scope of the present teaching.

A method of and a system for providing a computerized forecast system in accordance with the present teaching can be implemented in software, firmware, hardware, or a combination thereof. In one mode, a method of and a system for generating a forecast is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Servers or client devices or any computing means may be provided for generating the digital data record. The server or client device may include one or more processors and may include a distributed architecture with multiple nodes. It will be appreciated that the claimed method may be implemented on a cloud computing platform having a distributed network of nodes. The nodes may include one or more processing units as will be appreciated by those of ordinary skill in the art.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) residing on servers may be programmed to perform the functions of the inter-related data elements of FIG. 1 for example. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor, Inc. Client device 100 may also represent a distributed processing architecture such as, but not limited to, SQL, Smalltalk, APL, Erlang, Scala , Hadoop, BigTable, Amazon EC2, Microsoft Azure, NoSQL databases and Cloud Computing. It will be appreciated that the system may implemented on a distributed processing architecture.

Memory is associated with processor(s) and is operable to receive data. Memory can include any one or a combination of volatile memory elements (e.g., random access memory (RAM, such as DRAM, SRAM, SDRAM, etc.) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions of the workflow. In the example heretofore described, the software in memory includes one or more components of the method of and a system of the present teaching and is executable on a suitable operating system (O/S). A non-exhaustive list of examples of suitable commercially available operating systems is as follows: (a) a Windows operating system available from Microsoft Corporation; (b) an Apple iOS available from Apple Computer, Inc ; (c) a Macintosh operating system available from Apple Computer, Inc.; (d) a UNIX operating system, which is available for purchase from many vendors, such as the Hewlett-Packard Company, Oracle Inc.; (e) a LINUX operating system, which is freeware that is readily available on the Internet; or (f) an appliance-based operating system, such as that implemented in handheld computers, tablets or personal digital assistants (PDAs) (e.g. Apple iOS, Android, Roku). The operating system essentially controls the execution of other computer programs, such as that provided by the present teaching, and provides scheduling, input-output control, file and data management, memory management, and communication control and related services.

The system provided in accordance with the present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices and components of the client device may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

When the method of and system of the present teaching is implemented in software, it should be noted that such software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), Digital Video Disc (DVD), Universal Serial Bus (USB) and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Any process descriptions in the accompanying Figures, should be understood as representing modules, segments, or portions of code which include one or more executable instructions for implementing specific logical functions or steps in the process/workflow, and alternate implementations are included within the scope of the embodiments of the present teaching in which functions may be executed out of order from that shown or discussed, including substantially concurrently or in reverse order, depending on the functionality involved, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the invention. All such modifications are intended to be included herein within the scope of this disclosure and the present invention and protected by the following claims.

Although certain example methods, apparatus, systems and articles of manufacture have been described herein, the scope of coverage of this application is not limited thereto. On the contrary, this application covers all methods, systems, apparatus and articles of manufacture fairly falling within the scope of the appended claims.

The words comprises/comprising when used in this specification are to specify the presence of stated features, integers, steps or components but does not preclude the presence or addition of one or more other features, integers, steps, components or groups thereof.

1. A forecasting system provided on one or more interconnected computers, the forecasting system comprising:
a set of instructions executable by at least one of the one or more computers to generate one or more forecasts, the set of instructions comprising;
a forecast model creation module comprising rules to generate a forecast model data architecture comprising a plurality of attributes, wherein these attributes include:
a submission frequency rule which includes start, end, and frequency of forecast submissions.
a base time frequency for the architecture, which defines the required granularity of each forecast in a first unit of time.
at least one longer time frequency for the architecture, each longer time frequency defining a unit of time longer in time duration than the first unit of time.
a start period and start date for the one or more forecasts.

2. The system of claim 1, wherein the set of instructions further comprises instructions to generate a series of forecast submissions based on the forecast model data architecture attributes, wherein each forecast submission contains
a series of periods of one or more time frequencies
a list of organization reporting structures which are reporting forecasts
a list of currencies for each reporting structure
a list of forecast items associated each reporting structure

3. The system of claim 1, wherein the set of instructions further comprise instructions to:
generate a set of actual records which are used to hold actual results for comparison with forecasts.

4. The system of claim 1, wherein the set of instructions further comprise instructions to:
Generate a user interface to allow user entry of at least one of actuals data or forecasts data

5. The system of claim 1 configured, on determination of concurrent user entry of actuals data and forecasts data, to generate a two dimensional data structure for storing said actuals data and forecasts data.

6. The system of claim 1 configured to generate a series of linked individual forecasts, each of the linked individual forecasts including data related to a period defining that individual forecast, the system further comprising:
a forecast rollover controller comprising computer implemented instructions providing at least one of:
definition of composition of an individual forecast
a copy function for copying forecast data from a first forecast into a second forecast, where the first forecast defines a forecast for a time period that is after a start period of the second forecast and both forecasts are for the same time duration and the same forecast frequency.
a copy function for copying forecast data from forecast data related to a first time duration period into a second time duration time period where the first time duration period is longer than the second time duration period and
a copy function for copying forecast data from a first forecast into a second forecast, where the first forecast period is after the start period of the second forecast period, the second forecast period having a shorter duration period than the first forecast period and wherein the copying is effected by operably copying data from the first forecast into one of a last, first, or midpoint of a second forecast provided within the series of linked individual forecasts.

7. The computer system of claim 6, wherein the forecast rollover controller contains a set of instructions further comprises instructions to version all submissions of the series of linked individual forecasts enabling cross analysis of all series to one another or actuals data.

8. The computer system of claim 6 comprising an administrative interface providing a user interface to allow entry of data pertaining to individual forecasts or a series of forecasts

9. A forecasting system provided on one or more interconnected computers, the forecasting system comprising:
a set of instructions executable by at least one of the one or more computers to generate one or more forecasts, the set of instructions comprising a forecast calendar management model creation module comprising rules to manage a manage a relationship between a Gregorian calendar and a financial year calendar wherein the rules comprise:
rules to define start and end periods of the financial year calendar in the Gregorian calendar;
rules to define available time durations for use in generating a financial forecast;
rules to map time frequencies to the Gregorian calendar;
rules to define one or more relationships between time durations of a first period and time durations of a second period, the second period being less than the first period.

10. The forecasting system of claim 9 wherein the time durations of the first period have a start period indicia and an end period indicia which correspond with indicia associated with the time durations of the second period.

11. The forecasting system of claim 9 comprising a controller configured to allow association of names with each of the time periods to assign name to the periods to align with financial naming conventions.
